(19) United States
(12) Patent Application Publication
(10) Pub. No.: US 2024/0311895 A1
(43) Pub. Date: Sep. 19, 2024

(54) SYSTEMS AND METHODS FOR OPTIMIZING AGGREGATE VALUES FOR A REQUEST FOR QUOTATION

(71) Applicant: Honeywell International Inc., Charlotte, NC (US)

(72) Inventors: Mitchell O'BRIEN, Tempe, AZ (US); Himadri PAL, Sugar Land, TX (US); Gauri CHAWARE, Amherst, MA (US)

(21) Appl. No.: 18/184,393

(22) Filed: Mar. 15, 2023

(51) Int. Cl. G06Q 30/0601; G06N 20/20

(52) U.S. Cl. CPC G06Q 30/0633; G06N 20/20

(57) ABSTRACT

A method for optimizing aggregate values for a request for quotation is provided. The method includes: receiving data associated with a request for quotation for one or more items, the request for quotation including a respective quantity associated with each of the one or more items; assigning, using a first trained machine learning model, one or more aggregate values to the request for quotation; assigning, using a second trained machine learning model, a respective win probability for each of the one or more aggregate values; transmitting the one or more aggregate values and the one or more win probabilities associated with each of the one or more aggregate values to an electronic database; and transmitting the one or more aggregate values and the one or more win probabilities associated with each of the one or more aggregate values to a graphical user interface.

### TECHNICAL FIELD

Various embodiments of the present disclosure relate generally to systems and methods for optimizing aggregate values for a request for quotation, and, more particularly, to systems and methods for using artificial intelligence to assign one or more aggregate values to a request for quotation and assign a win probability to each of the one or more aggregate values.

### BACKGROUND

Customers often come to providers of products with a list of products they are looking to purchase. Determining a pricing strategy for a list of products provides a challenging problem. A price is necessary that optimizes profit and likelihood of winning an opportunity to provide items in a request for quotation in a competitive atmosphere. Historically, this problem requires the inputs of many pricing experts of different products and incorporates many factors such as customer relationship, demand for the products, number and nature of competitors, and other market conditions. This may lead to a subjective best guess as to the highest price that can be charged while still beating out the other competitors for the opportunity. These subjective best guesses leave room for uncertainty about whether a higher price could have been charged for opportunities won, turning a higher profit, or whether a lower price could have turned a lost opportunity into a win. This problem may be abstracted to provide insights into other optimization problems.

The present disclosure is directed to overcoming one or more of these above-referenced challenges.

### SUMMARY OF THE DISCLOSURE

The present disclosure is directed systems and methods for optimizing aggregate values for a request for quotation, the method comprising: receiving data associated with a request for quotation for one or more items, the request for quotation including a respective quantity associated with each of the one or more items; assigning, using a first trained machine learning model, one or more aggregate values to the request for quotation based on the one or more items and the one or more quantities and a learned association between the one or more items, the one or more quantities, and the one or more aggregate values; assigning, using a second trained machine learning model, a respective win probability for each of the one or more aggregate values based on a learned association between the one or more aggregate values and the respective win probability; transmitting the one or more aggregate values and the one or more win probabilities associated with each of the one or more aggregate values to an electronic database; and transmitting the one or more aggregate values and the one or more win probabilities associated with each of the one or more aggregate values to a graphical user interface.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a system for using artificial intelligence to optimize aggregate values in response to a request for quotation, according to one or more embodiments.

FIG. 2 depicts a flowchart of a method of using artificial intelligence to optimize aggregate values in response to a request for quotation, according to one or more embodiments.

FIG. 3 depicts a flowchart of a method of training machine learning models to optimize aggregate values in response to a request for quotation, according to one or more embodiments.

FIG. 4 depicts an exemplary implementation of a controller that may execute techniques presented herein, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value. In this disclosure, unless stated otherwise, “automatically” is used to indicate that an operation is performed without user input or intervention.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Customers often come to providers of products with a list of products they are looking to purchase. Determining a pricing strategy for a list of products provides a challenging problem. A price is necessary that optimizes profit and likelihood of winning an opportunity for a sale in a competitive pricing market. Historically, this problem requires the inputs of many pricing experts of different products and incorporates many factors such as customer relationship, demand for the products, number and nature of competitors, and other market conditions. This may lead to a subjective best guess as to the highest price that can be charged while still beating out the other competitors for the opportunity. These subjective best guesses leave room for uncertainty about whether a higher price could have been charged for opportunities won, turning a higher profit, or whether a lower price could have turned a lost opportunity into a win. This problem may be abstracted to provide insights into other optimization problems.

One or more embodiments may provide a system that uses artificial intelligence to provide optimal price recommendations for particular sets of products that maximize profits based on customer standing, order quantity, inflation, regional price differences, and other factors. The price recommendations made by the system may also be based on historical data related to requests for quotations won and lost for similar or identical sets of products. The price recommendations may include a range of price recommendations and provide information about likelihood of winning at each price.

One or more embodiments may collect data related to historical wins and losses based on a variety of requests for quotations for a variety of products. The collected data may be used to train a machine learning system, such as a neural network, for example, to analyze the collected data, such as by performing sentiment analysis, for example. The system may use artificial intelligence techniques to identify and categorize the collected data related to the historical wins and losses based on requests for quotations, and identify one or more price recommendations and one or more win/loss likelihoods for the price recommendations correlated with a given request for quotation.

One or more embodiments may provide analysts with a better indication of an optimal price and win/loss percentage, which may reduce the amount of time and effort expended on referring to historical data, macroeconomic trends, costs, inventory and other factors to arrive at a best guess or estimate, and may further reduce the uncertainty about whether a higher price could have been charged for opportunities won, turning a higher profit, or whether a lower price could have turned a lost opportunity into a win.

The system may be implemented in a quotation win probability engine including an existing electronic database comprising the historical wins and losses based on past requests for quotations for products, and may be connected via a network to other databases that provide other inputs to machine learning models used by the system to determine optimized price recommendations and win probabilities, the other databases providing information relating to inflation and other macroeconomic data and other historical sales and price data for products related to a pertinent request for quotation.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case with a set of databases and an engine for receiving requests for quotations, a trained machine learning model may be used to determine an aggregate value or a set of aggregate values for the set of products in the request for quotation, and another trained machine learning model may determine the win/loss probabilities for the price or set of prices, or recommend a price from the set of prices with the highest win probability for the input request for quotation. The machine learning model for the aggregate value determination and the machine learning model for the win/loss probabilities may be separate machine learning models, or they may be sub-models of a single machine learning model.

While the example above involves a request for quotation, it should be understood that techniques according to this disclosure may be adapted to any suitable type of data or data structure expressed in a database. It should also be understood that the example above is illustrative only. The techniques and technologies of this disclosure may be adapted to any suitable activity.

Presented below are various aspects of machine learning techniques that may be adapted to analyze requests for quotations. As will be discussed in more detail below, machine learning techniques adapted to evaluate and generate price recommendations and win/loss probabilities for requests for quotations may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

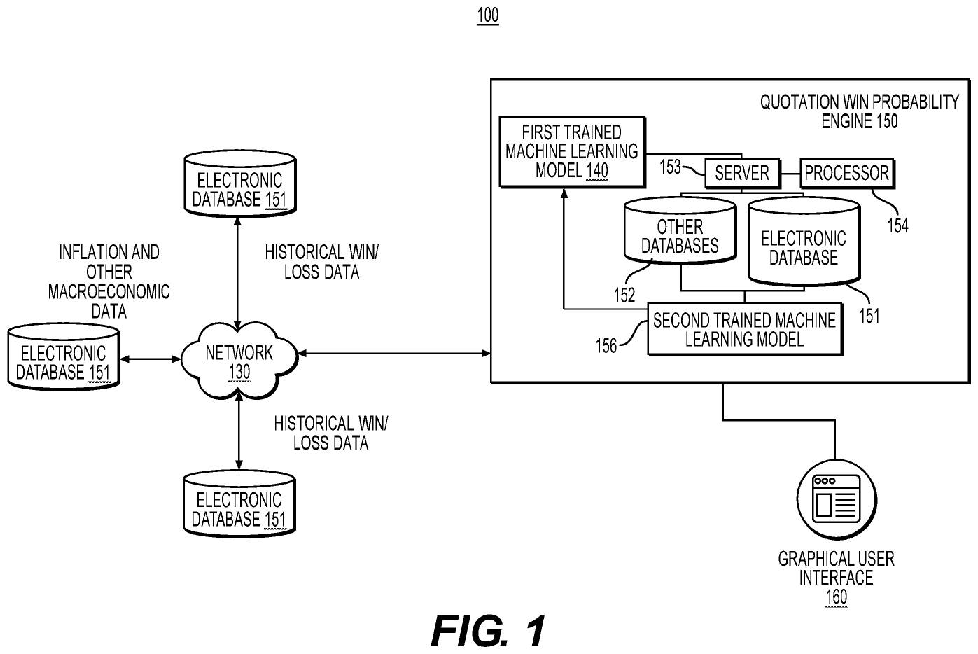

FIG. 1 depicts an example of an environment 100 that may be utilized with techniques presented herein. One or more electronic databases 151 and a quotation win probability engine system 150 may communicate across an electronic network 130. In some embodiments, the quotation win probability engine system 150 may comprise a server 153, an electronic database 151, one or more other databases 152, a first trained machine learning model 140, and a second trained machine learning model 156. The quotation win probability engine system 150 may be integrated with, or separate from (but connected to or otherwise in communication with), a GUI 160. The GUI 160 may be implemented on any device capable of visual or tactile presentation of data and images in a form intelligible to a user. In some embodiments, the GUI 160 may present information dynamically in a visual medium. In some other embodiments, the GUI 160 may support a tactile display (display that may be felt by the fingers—and intended for the visually impaired) of data and images. In some embodiments, the GUI 160 supporting a tactile display may further be audio-enabled, such that parameter elements are associated with one or more sounds (e.g. musical tones, filtered noises, recorded sound effects, synthesized speech, and the like), in order to further assist a visually impaired user utilizing the display. Non-limiting examples of the display on which the GUI 160 is implemented may include a cathode ray tube, a liquid crystal display, a light emitting display, a plasma display, etc. In some embodiments, the GUI 160 may also accept user inputs. In these embodiments, the GUI 160 may be implemented on a device that may include a touch screen where information may be entered by selecting one of multiple options presented on the display. Selecting an option may be accomplished using a mouse (as is well known in the art), or touching an area of the display. In some embodiments, GUI 160 may be implemented on two or more displays in communication with the quotation win probability engine system 150. As will be discussed in further detail below, a quotation win probability engine system 150 may communicate with one or more of the other components of the environment 100 across electronic network 130. The one or more electronic databases 151 may be associated with a user, e.g., a user associated with one or more of generating, training, or tuning a machine-learning model for generating, obtaining, or analyzing data, and/or generating or entering requests for quotations.

In some embodiments, the components of the environment 100 are associated with a common entity, e.g., a transaction processor, merchant, business enterprise, or the like. In some embodiments, one or more of the components of the environment is associated with a different entity than another. The systems, devices and databases of the environment 100 may communicate in any arrangement. As will be discussed herein, systems and/or databases of the environment 100 may communicate in order to one or more of generate, train, or use a machine-learning model to analyze occasion data and generate occasion requests, among other activities.

The electronic database 151 may be configured to enable the user to access and/or interact with other systems in the environment 100. For example, the electronic database 151 may be connected to a computer system such as, for example, a desktop computer, a mobile device, a tablet, etc. In some embodiments, the electronic database 151 include one or more electronic application(s), e.g., a program, plugin, browser extension, etc., installed on a memory of the computer system connected to the electronic database 151. In some embodiments, the electronic application(s) may be associated with one or more of the other components in the environment 100.

The electronic database 151 may include a server system, an electronic medical data system, computer-readable memory such as a hard drive, flash drive, disk, etc. In some embodiments, the electronic database 151 includes and/or interacts with an application programming interface for exchanging data to other systems, e.g., one or more of the other components of the environment. The electronic database 151 may include and/or act as a repository or source for data related to past and current requests for quotations, and data related to products that have been part of past or current requests for quotations and sales transactions, as discussed in more detail below.

In various embodiments, the electronic network 130 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As discussed in further detail below, the quotation win probability engine system 150 may one or more of (i) generate, store, train, or use one or more machine-learning models configured to analyze new requests for quotations and historical data related to past requests for quotations and transactions including products involved in past or current requests for transactions and suggest price recommendations or sets of price recommendations and/or win probabilities for the prices for the current request for quotation. The quotation win probability engine system 150 may include a machine-learning model and/or instructions associated with the machine-learning model, e.g., instructions for generating a machine-learning model, training the machine-learning model, using the machine-learning model etc. The quotation win probability engine system 150 may include instructions for retrieving historical data, adjusting quotation win probability data, e.g., based on the output of the machine-learning model, and/or operating the GUI 160 to output quotation win probability data, e.g., as adjusted based on the machine-learning model. The quotation win probability engine system 150 may include training data, e.g., historical requests for quotations and sales prices 110, and may include ground truth, e.g., historical win/loss data 120.

In some embodiments, a system or device other than quotation win probability engine system 150 is used to generate and/or train the machine-learning model. For example, such a system may include instructions for generating the one or more machine-learning models, the training data and ground truth, and/or instructions for training the machine-learning model. A resulting trained-machine-learning model may then be provided to the quotation win probability engine system 150.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of a first machine-learning model may be configured to cause the machine-learning model to learn associations between training data that includes information regarding one or more requests for quotation associated with one or more electronic databases and win/loss data including a win or loss for each of one or more requests for quotation to learn relationships between the training data and the win/loss data, such that the trained machine-learning model is configured to determine an output to generate a new price recommendation that will result in an optimal price recommendation based on the learned associations. The training of a second machine-learning model may be configured to cause the machine-learning model to learn associations between training data that includes information regarding one or more occasions associated with one or more electronic databases and training value data that includes a prior timing value and substance value for each of the one or more occasions data, such that the trained machine-learning model is configured to determine an output substance value and timing value for a new occasion in response to the input of data associated with a request to add a new occasion to the electronic database based on the learned associations.

Although depicted as separate components in FIG. 1, it should be understood that a component or a portion of a component in the environment 100 may, in some embodiments, be integrated with or incorporated into one or more other components. For example, a portion of the GUI 160 may be integrated into electronic database 151 or the like. In another example, the quotation win probability engine system 150 may be integrated with an electronic database 151. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to generate and/or analyze requests to add a new occasion to a database are discussed in further detail in the methods below. In the following methods, various acts may be described as performed or executed by a component from FIG. 1, such as the quotation win probability engine system 150, the electronic database 151, or components thereof. However, it should be understood that in various embodiments, various components of the environment 100 discussed above may execute instructions or perform acts including the acts discussed below. An act performed by a device or system may be considered to be performed by a processor, actuator, or the like associated with that device or system. Further, it should be understood that in various embodiments, various steps may be added, omitted, and/or rearranged in any suitable manner.

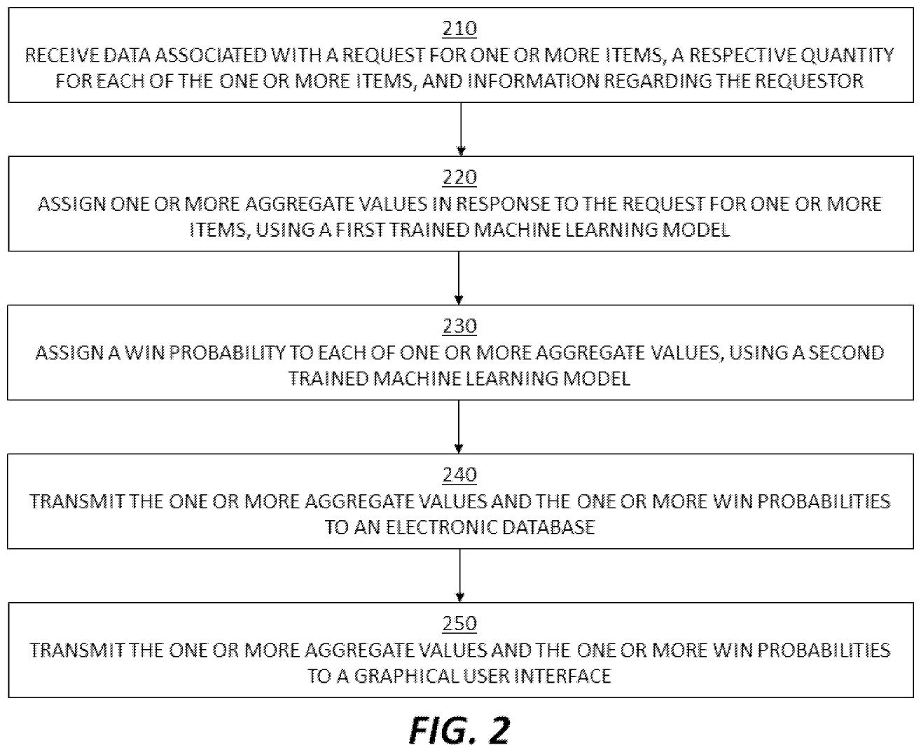

FIG. 2 depicts an exemplary process 200 for using a trained machine-learning model to analyze data in a database to evaluate new requests for quotations, such as in the example discussed above. At step 210, the quotation win probability engine system 150 may receive data associated with a request for quotation for a specified set of items or products from an electronic database 151. The request may include a set of items including one more items, a requested quantity associated with each item, and information relating to the requestor, including but not limited to the requestor's standing with the requestee, also referred to as customer standing, and the requestor's region. Customer standing may include factors such as length of relationship with requestee, frequency and magnitude of orders over the course of the relationship, and other factors such as on-time payments, etc. The customer standing may include a value to represent positive or negative customer standing, and the magnitude of the value may represent the magnitude of the standing. For example, a customer standing value of +10 may be the highest possible customer standing, and a customer standing value of −10 the lowest. Alternatively, the base for customer standing may begin at 0 and factors may increase or decrease customer standing from there without bounds. Also stored in the electronic database 151 of quotation win probability engine system 150 and/or retrieved from external electronic databases 151 are macroeconomic trends, including but not limited to, inflation figures, price fluctuation information for commodities and products, and historical differences in pricing by region in the world.

At step 220, quotation win probability engine system 150 assigns at least one aggregate value in response to the request for quotation received at step 205, using a first trained machine learning model 140. The at least one aggregate value represents a summation of a value for each item multiplied by a quantity for each item in the request for quotation. In an exemplary embodiment, the value for each item represents an optimal sale price for each item given the order quantity, the customer standing, the macroeconomic data, and the region in which the requestor is based. The optimal sale price is determined by the trained machine learning model to maximize the profit for the request for quotation. Maximizing the profit for a request for quotation involves increasing the margin on each item until it is no longer likely that the aggregate value representing the price for all the quantity of items would win the request for quotation.

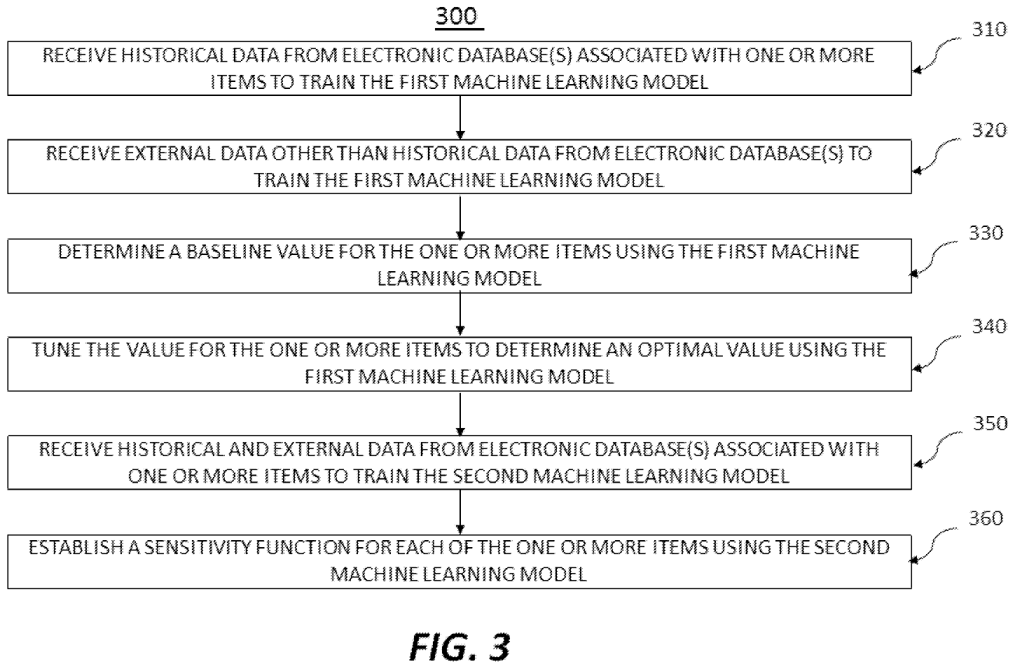

For example, and without limitation, a request for quotation may include a request for ten units of item A, fifty units of item B, and one hundred units of item C. The requestor may be a longstanding customer with good customer standing, and based in a region where goods are relatively expensive. Furthermore, the macroeconomic data retrieved by the quotation win probability engine may indicate that the prices for item A have increased in the last several months, while prices for items B and C have dropped precipitously. All of this information is received by the quotation win probability engine and the first trained machine learning model 140 assigns at least one aggregate value for the request for quotation. In this example, the aggregate value represents at least one recommended selling price for ten of item A, fifty of item B, and one hundred of item C. The first trained machine learning model 140 may provide a range of aggregate values, or a number of discrete assigned aggregate values within a range. The training of the first machine learning model 140 will be described in more detail with reference to FIG. 3 below.

At step 230, the quotation win probability engine system 150 assigns a win probability to the at least one assigned aggregate value using the second trained machine learning model 156. In an exemplary embodiment, the win probability represents a likelihood that, at a sale price for each item given the order quantity, the customer standing, the macroeconomic data, and the region in which the requestor is based, the request for quotation is likely to be accepted by the requestor. The win probability is determined by the second trained machine learning model 156 based on similar inputs as to the first trained machine learning model, namely customer standing, macroeconomic data, particularly for the items in the request for quotation. Maximizing the profit for a request for quotation involves increasing the margin on each item until it is no longer likely that the aggregate value representing the price for all the quantity of items would win the request for quotation. The training of the second machine learning model 156 will be described in more detail with reference to FIG. 3 below.

For example, and without limitation, in the above example where the request for quotation included a request for ten of item A, fifty of item B, and one hundred of item C, the quotation win probability engine system 150 may assign a win probability of 90% to an aggregate value for the request of 1000 units using the second trained machine learning model 156, where the units may be dollars or any other quantifiable unit, a win probability of 80% to an aggregate value of 1500 units, and a win probability of 70% to an aggregate value of 1750 units. The engine may also assign a continuous set of win probabilities in the form of a continuous graph from 0 to an asymptotically large value, or it may be tuned to include only win probabilities of interest to the requestee, such as, and without limitation, win probabilities over 25% or win probabilities over 75%.

At step 240, the quotation win probability engine system 150 may transmit to and store in the electronic database 151 the aggregate values and win probabilities output by the first and second trained machine learning models 140 and 156. The first and second machine learning models may then access these computed values at a later date with the ground truth of the final aggregate value offered to the requestor and the determination if the final aggregate value won the request for quotation. In this way, the models may continue to be trained using ongoing data. Training of the machine learning models will be described in more detail with respect to FIG. 3 below.

At step 250, quotation win probability engine system 150 transmits at least one of the at least one aggregate values and at least one of the correlated win probabilities to GUI 160. The GUI 160 may be implemented on any device capable of visual or tactile presentation of data and images in a form intelligible to a user. In some embodiments, the GUI 160 may present information dynamically in a visual medium. In some other embodiments, the GUI 160 may support a tactile display (display that may be felt by the fingers—and intended for the visually impaired) of data and images. In some embodiments, the GUI 160 supporting a tactile display may further be audio-enabled, such that parameter elements are associated with one or more sounds (e.g. musical tones, filtered noises, recorded sound effects, synthesized speech, and the like), in order to further assist a visually impaired user utilizing the display. Non-limiting examples of the display on which the GUI 160 is implemented may include a cathode ray tube, a liquid crystal display, a light emitting display, a plasma display, etc. In some embodiments, the GUI 160 may also accept user inputs. In these embodiments, the GUI 160 may be implemented on a device that may include a touch screen where information may be entered by selecting one of multiple options presented on the display. Selecting an option may be accomplished using a mouse (as is well known in the art), or touching an area of the display. In some embodiments, GUI 160 may be implemented on two or more displays in communication with the quotation win probability engine system 150.

A user may dictate what is transmitted to GUI 160, or it may be automatically transmitted by quotation win probability engine system 150 based on a default setting. In one exemplary embodiment, the quotation win probability engine system 150 may be set to transmit a graphical representation of the win probability for a range of aggregate values. In one non-limiting example, this may be in the form of a graph, with the x-axis representing aggregate values for the request for quotation, and the y-axis representing win probabilities. In another non-limiting example, the graphical representation may be in the form of an alternate graph, with the x-axis representing profit margins for the request for quotation, and the y-axis representing win probabilities.

In another exemplary embodiment, the quotation win probability engine system 150 may transmit to GUI 160 a dynamic display, with one or more of the graphs described above and selectable links at a number of points on the chart, at least one of the selectable links being a recommended optimal aggregate value that represents an optimal score for high profit and high win probability as determined by the first and second trained machine learning models 140 and 156.

In yet another exemplary embodiment, the information may be transmitted to the GUI 160 in chart form, with columns representing aggregate value, profit margin, and win probability. Optionally, one or more of the aggregate values may be highlighted for easy readability. In one non-limiting example, the recommended optimal aggregate value may be highlighted, along with aggregate values with win probabilities of 90% and 50%. The highlighting may include a change in font, font size, style or color, different background shading, or any other known method for increasing visibility of selected data over other data. In another non-limiting example, the recommended optimal aggregate value may be presented set apart from the remainder of the aggregate values, and/or select aggregate values such as the 90% win probability aggregate value and the 50% aggregate value may be set apart as well in a similar fashion as to the recommended value.

FIG. 3 illustrates an exemplary process 300 for training and tuning the first and second machine learning models 140 and 156 according to one or more embodiments. The first and second machine learning models 140 and 156 may be separate machine learning models, or they may be sub-models of a single machine learning model. At step 310, the quotation win probability engine system 150 may retrieve historical data from electronic databases 151. The electronic database(s) 151 may be incorporated in the quotation win probability engine system 150 and/or be provided external to the quotation win probability engine system 150, as shown in FIG. 1. The historical data may include past requests for quotation, including the items and quantities associated with each of the past requests for quotation, the requestor of the requests for quotation, including the customer standing for each requestor and the region in which the requestor resides or otherwise made the request from. Additionally, the historical data may include the aggregate value, or price, of the quotation made in response to the request for quotation, the margin, or profit, made if the quotation won or would have made had the quotation won (if the quotation did not win), and an indication of whether the quote was won or lost. This data forms the basis of the training data to determine optimal aggregate values and win probabilities for new requests for quotations.

At step 320, the quotation win probability engine system 150 may receive from electronic databases 151 other external data relevant to requests for quotations, including but not limited to macroeconomic data. The macroeconomic data may include inflation data, and more specific price fluctuations affecting commodities that may affect the price of items that may be requested, and/or prices of items that may be requested directly as well. This information may be automatically retrieved periodically by the quotation win probability engine system 150, for example, every day, every week, or every two weeks, etc. It may also be retrieved on a continuous real-time basis. Alternatively or additionally, it may be retrieved each time a new request for quotation is received.

At step 330, the first machine learning model 140 determines a baseline value for a given item at a given quantity based on the historical data. The model 140 may use an envelope function to smooth a curve associated with a graph for a given item from the historical data to arrive at a baseline value for a given item and quantity. The graph aggregates the sale prices of an item at a number of given quantities. There may be spikes at different prices that do not necessarily correlate to intuitive expectations about the relationship between sale price and quantity. However, the envelope function allows for the relationship between total profit and unit price to be modeled and smoothed, outlining its extremes. A Gaussian distribution may be used as a base function for the envelope and parameterized by amplitude, mean, and standard deviation. The first machine learning model 140 uses this information to arrive at a unit price for a given quantity of a given item that corresponds to an optimal margin given historic win/loss data. This establishes a baseline price recommendation for a given item and given quantity. Step 330 may be repeated for other items in other quantities to arrive at an aggregate value for a request for quotation that includes multiple items and multiple quantities. Furthermore, the value for an item is adjusted for a given quantity by finding a linear slope of the envelope function in regions near the optimal value. In one embodiment, the linear slope is determined by fitting a linear regression on the envelope function to extract the slope. In an alternate embodiment, a slope may be created as a function of a list price of the item. The linear slope determines an adjustment of the value for the item with respect to quantity, with lower per item values for higher quantities, and higher per item prices or values for lower quantities. In a further embodiment, both slopes may be calculated and the greater of the two slopes may be used to adjust for quantities.

At step 340, the first machine learning model further tunes the baseline price recommendation, or the baseline value proposition for a given item at a given quantity, based on other factors such as customer standing, region, and macroeconomic factors. For example, an optimization process may be performed at the country level by the quotation win probability engine 150 to tune the first machine learning model to establish, for example, low, medium and high price points based on different countries or regions. If a customer or requestee is based in a region with low price points, the adjustment may be made to offer a lower value quotation for a given item based on the low price point. If a customer or requestee is based in a region with high price point, the adjustment may be made to offer a higher value quotation. Furthermore, the first machine learning model may receive from electronic databases 151 as input a customer standing score. As described above, customer standing may include factors such as length of relationship with requestee, frequency and magnitude of orders over the course of the relationship, and other factors such as on-time payments, etc. The customer standing may include a value to represent positive or negative customer standing, and the magnitude of the value may represent the magnitude of the standing. For example, a customer standing value of +10 may be the highest possible customer standing, and a customer standing value of −10 the lowest. Alternatively, the base for customer standing may begin at 0 and factors may increase or decrease customer standing from there without bounds.

At step 350, the second machine learning model 156 retrieves historical data and macroeconomic data from electronic databases 151, and further receives data from electronic databases 151 that includes the outputs of the first trained machine learning model. This data includes historic wins and losses across a variety of items, quantities, and requestors, and further includes data regarding level of competition for a quotation, a distribution channel, a price ratio, and a discount ratio. The price ratio may be defined as the selling price of a given item as a proportion of the list price for the given item, where the list price reflects a standard price point for the item absent any other information regarding the item. The discount ratio may be defined as an actual discount offered for a given item as a proportion of a discount requested by the requestor for the given item.

At step 360, the second machine learning model 156 may establish a sensitivity function for a variety of items and quantities. The sensitivity function determines how the probability of winning a request for quotation is affected by variations in aggregate value from a highest win probability aggregate value.

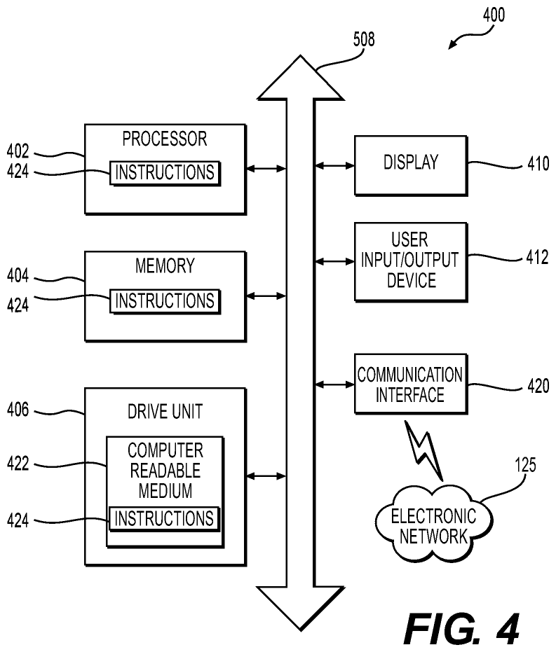

FIG. 4 depicts an implementation of a controller 400 that may execute techniques presented herein, according to one or more embodiments. The controller 400 may include a set of instructions that can be executed to cause the controller 400 to perform any one or more of the methods or computer based functions disclosed herein. The controller 400 may operate as a standalone device or may be connected, e.g., using a network, to other computer systems or peripheral devices.

In a networked deployment, the controller 400 may operate in the capacity of a server or as a client in a server-client user network environment, or as a peer computer system in a peer-to-peer (or distributed) network environment. The controller 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 400 can be implemented using electronic devices that provide voice, video, or data communication. Further, while the controller 400 is illustrated as a single system, the term “system” shall also be taken to include any collection of systems or sub-systems that individually or jointly execute a set, or multiple sets, of instructions to perform one or more computer functions.

As illustrated in FIG. 4, the controller 400 may include a processor 402, e.g., a central processing unit (CPU), a graphics processing unit (GPU), or both. The processor 402 may be a component in a variety of systems. For example, the processor 402 may be part of a standard computer. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The controller 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the controller 400 may further include a display 410, such as a liquid crystal display (LCD), an organic light emitting diode (OLED), a flat panel display, a solid-state display, a cathode ray tube (CRT), a projector, a printer or other now known or later developed display device for outputting determined information. The display 410 may act as an interface for the user to see the functioning of the processor 402, or specifically as an interface with the software stored in the memory 404 or in the drive unit 406.

Additionally or alternatively, the controller 400 may include an input device 412 configured to allow a user to interact with any of the components of controller 400. The input device 412 may be a number pad, a keyboard, or a cursor control device, such as a mouse, or a joystick, touch screen display, remote control, or any other device operative to interact with the controller 400.

The controller 400 may also or alternatively include drive unit 406 implemented as a disk or optical drive. The drive unit 406 may include a computer-readable medium 422 in which one or more sets of instructions 424, e.g. software, can be embedded. Further, the instructions 424 may embody one or more of the methods or logic as described herein. The instructions 424 may reside completely or partially within the memory 404 and/or within the processor 402 during execution by the controller 400. The memory 404 and the processor 402 also may include computer-readable media as discussed above.

In some systems, a computer-readable medium 422 includes instructions 424 or receives and executes instructions 424 responsive to a propagated signal so that a device connected to a network 470 can communicate voice, video, audio, images, or any other data over the network 470. Further, the instructions 424 may be transmitted or received over the network 470 via a communication port or interface 420, and/or using a bus 408. The communication port or interface 420 may be a part of the processor 402 or may be a separate component. The communication port or interface 420 may be created in software or may be a physical connection in hardware. The communication port or interface 420 may be configured to connect with a network 470, external media, the display 410, or any other components in controller 400, or combinations thereof. The connection with the network 470 may be a physical connection, such as a wired Ethernet connection or may be established wirelessly as discussed below. Likewise, the additional connections with other components of the controller 400 may be physical connections or may be established wirelessly. The network 470 may alternatively be directly connected to a bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 422 may be non-transitory, and may be tangible.

The computer-readable medium 422 can include a solid-state memory such as a memory card or other package that houses one or more non-volatile read-only memories. The computer-readable medium 422 can be a random-access memory or other volatile re-writable memory. Additionally or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 400 may be connected to a network 470. The network 470 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 470 may include wide area networks (WAN), such as the Internet, local area networks (LAN), campus area networks, metropolitan area networks, a direct connection such as through a Universal Serial Bus (USB) port, or any other networks that may allow for data communication. The network 470 may be configured to couple one computing device to another computing device to enable communication of data between the devices. The network 470 may generally be enabled to employ any form of machine-readable media for communicating information from one device to another. The network 470 may include communication methods by which information may travel between computing devices. The network 470 may be divided into sub-networks. The sub-networks may allow access to all of the other components connected thereto or the sub-networks may restrict access between the components. The network 470 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for optimizing aggregate values for a request for quotation, the method comprising:
receiving data associated with a request for quotation for one or more items, the request for quotation including a respective quantity associated with each of the one or more items;
assigning, using a first trained machine learning model, one or more aggregate values to the request for quotation based on the one or more items and the one or more quantities and a learned association between the one or more items, the one or more quantities, and the one or more aggregate values;
assigning, using a second trained machine learning model, a respective win probability for each of the one or more aggregate values based on a learned association between the one or more aggregate values and the respective win probability;
transmitting the one or more aggregate values and the one or more win probabilities associated with each of the one or more aggregate values to an electronic database; and
transmitting the one or more aggregate values and the one or more win probabilities associated with each of the one or more aggregate values to a graphical user interface.

2. The method of claim 1, wherein the data associated with the request for quotation includes information regarding the requestor and historical data associated with prior requests for quotation associated with the one or more items.

3. The method of claim 1, wherein the step of assigning the one or more aggregate values comprises:
determining a baseline value for each of the one or more items using the first trained machine learning model;
tuning the baseline value, using the first trained machine learning model, to arrive at an optimal value for each of the one or more items;
multiplying the optimal value for each of the one or more items by the respective quantity for each of the one or more items to determine;
summing the multiple of the optimal value and quantity for each of the one or more items to arrive at the one or more aggregate values.

4. The method of claim 3, wherein the step of assigning the one or more win probabilities comprises:
receiving historical data associated with wins and losses of historical requests for quotations that included at least one of the one or more items in the request for quotation;
using the second trained machine learning model, calculating a win probability for each of the one or more aggregate values based on a learned association between the aggregate value and the historical data associated wins and losses of the historical requests for quotations.

5. The method of claim 4, wherein a first aggregate value of the one or more aggregate values represents a high aggregate value with a low win probability, a second aggregate value of the one or more aggregate values represents a low aggregate value with a high win probability, and a third aggregate value of the one or more aggregate values represents an optimal aggregate value with a medium win probability; and
the step of transmitting the one or more aggregate values and the one or more win probabilities associated with each of the one or more aggregate values to an electronic database comprises:
transmitting the first aggregate value, the second aggregate value, and the third aggregate value to the electronic database.

6. The method of claim 4, wherein a first aggregate value of the one or more aggregate values represents a high aggregate value with a low win probability, a second aggregate value of the one or more aggregate values represents a low aggregate value with a high win probability, and a third aggregate value of the one or more aggregate values represents an optimal aggregate value with a medium win probability; and
the step of transmitting the one or more aggregate values and the one or more win probabilities associated with each of the one or more aggregate values to a graphical user interface comprises:
transmitting the first aggregate value, the second aggregate value, and the third aggregate value to the graphical user interface.

7. The method of claim 4, further comprising:
generating a graph with the one or more aggregate values on a x-axis and the one or more win probabilities on a y-axis, wherein the step of the step of transmitting the one or more aggregate values and the one or more win probabilities associated with each of the one or more aggregate values to a graphical user interface comprises:
transmitting the graph to the graphical user interface.

8. A system for optimizing aggregate values for a request for quotation, the system comprising:
one or more processors configured to perform operations including:
receiving data associated with a request for quotation for one or more items, the request for quotation including a respective quantity associated with each of the one or more items;
assigning, using a first trained machine learning model, one or more aggregate values to the request for quotation based on the one or more items and the one or more quantities and a learned association between the one or more items, the one or more quantities, and the one or more aggregate values;
assigning, using a second trained machine learning model, a respective win probability for each of the one or more aggregate values based on a learned association between the one or more aggregate values and the respective win probability;
transmitting the one or more aggregate values and the one or more win probabilities associated with each of the one or more aggregate values to an electronic database; and
transmitting the one or more aggregate values and the one or more win probabilities associated with each of the one or more aggregate values to a graphical user interface.

9. The system of claim 8, wherein the data associated with the request for quotation includes information regarding the requestor and historical data associated with prior requests for quotation associated with the one or more items.

10. The system of claim 8, wherein the step of assigning the one or more aggregate values comprises:
determining a baseline value for each of the one or more items using the first trained machine learning model;
tuning the baseline value, using the first trained machine learning model, to arrive at an optimal value for each of the one or more items;
multiplying the optimal value for each of the one or more items by the respective quantity for each of the one or more items to determine;
summing the multiple of the optimal value and quantity for each of the one or more items to arrive at the one or more aggregate values.

11. The system of claim 10, wherein the step of assigning the one or more win probabilities comprises:
receiving historical data associated with wins and losses of historical requests for quotations that included at least one of the one or more items in the request for quotation;
using the second trained machine learning model, calculating a win probability for each of the one or more aggregate values based on a learned association between the aggregate value and the historical data associated wins and losses of the historical requests for quotations.

12. The system of claim 11, wherein a first aggregate value of the one or more aggregate values represents a high aggregate value with a low win probability, a second aggregate value of the one or more aggregate values represents a low aggregate value with a high win probability, and a third aggregate value of the one or more aggregate values represents an optimal aggregate value with a medium win probability; and
the step of transmitting the one or more aggregate values and the one or more win probabilities associated with each of the one or more aggregate values to an electronic database comprises:
transmitting the first aggregate value, the second aggregate value, and the third aggregate value to the electronic database.

13. The system of claim 11, wherein a first aggregate value of the one or more aggregate values represents a high aggregate value with a low win probability, a second aggregate value of the one or more aggregate values represents a low aggregate value with a high win probability, and a third aggregate value of the one or more aggregate values represents an optimal aggregate value with a medium win probability; and
the step of transmitting the one or more aggregate values and the one or more win probabilities associated with each of the one or more aggregate values to a graphical user interface comprises:
transmitting the first aggregate value, the second aggregate value, and the third aggregate value to the graphical user interface.

14. The system of claim 11, further comprising:
generating a graph with the one or more aggregate values on a x-axis and the one or more win probabilities on a y-axis, wherein the step of the step of transmitting the one or more aggregate values and the one or more win probabilities associated with each of the one or more aggregate values to a graphical user interface comprises:
transmitting the graph to the graphical user interface.

15. A non-transitory computer-readable medium storing instructions that, when executed by one or more processors, cause the one or more processors to perform operations for optimizing aggregate values for a request for quotation, the operations comprising:
receiving data associated with a request for quotation for one or more items, the request for quotation including a respective quantity associated with each of the one or more items;
assigning, using a first trained machine learning model, one or more aggregate values to the request for quotation based on the one or more items and the one or more quantities and a learned association between the one or more items, the one or more quantities, and the one or more aggregate values;
assigning, using a second trained machine learning model, a respective win probability for each of the one or more aggregate values based on a learned association between the one or more aggregate values and the respective win probability;
transmitting the one or more aggregate values and the one or more win probabilities associated with each of the one or more aggregate values to an electronic database; and
transmitting the one or more aggregate values and the one or more win probabilities associated with each of the one or more aggregate values to a graphical user interface.

16. The non-transitory computer-readable medium of claim 15, wherein the data associated with the request for quotation includes information regarding the requestor and historical data associated with prior requests for quotation associated with the one or more items.

17. The non-transitory computer-readable medium of claim 15, wherein the step of assigning the one or more aggregate values comprises:
determining a baseline value for each of the one or more items using the first trained machine learning model;
tuning the baseline value, using the first trained machine learning model, to arrive at an optimal value for each of the one or more items;
multiplying the optimal value for each of the one or more items by the respective quantity for each of the one or more items to determine;
summing the multiple of the optimal value and quantity for each of the one or more items to arrive at the one or more aggregate values.

18. The non-transitory computer-readable medium of claim 17, wherein the step of assigning the one or more win probabilities comprises:
receiving historical data associated with wins and losses of historical requests for quotations that included at least one of the one or more items in the request for quotation;
using the second trained machine learning model, calculating a win probability for each of the one or more aggregate values based on a learned association between the aggregate value and the historical data associated wins and losses of the historical requests for quotations.

19. The non-transitory computer-readable medium of claim 18, wherein a first aggregate value of the one or more aggregate values represents a high aggregate value with a low win probability, a second aggregate value of the one or more aggregate values represents a low aggregate value with a high win probability, and a third aggregate value of the one or more aggregate values represents an optimal aggregate value with a medium win probability; and
the step of transmitting the one or more aggregate values and the one or more win probabilities associated with each of the one or more aggregate values to an electronic database comprises:
transmitting the first aggregate value, the second aggregate value, and the third aggregate value to the electronic database.

20. The non-transitory computer-readable medium of claim 18, wherein a first aggregate value of the one or more aggregate values represents a high aggregate value with a low win probability, a second aggregate value of the one or more aggregate values represents a low aggregate value with a high win probability, and a third aggregate value of the one or more aggregate values represents an optimal aggregate value with a medium win probability; and
the step of transmitting the one or more aggregate values and the one or more win probabilities associated with each of the one or more aggregate values to a graphical user interface comprises:
transmitting the first aggregate value, the second aggregate value, and the third aggregate value to the graphical user interface.
